(19) United States
(12) Patent Application Publication
(10) Pub. No.: US 2017/0023182 A1
(43) Pub. Date: Jan. 26, 2017

(54) FLANGED PIPE CLOSURE

(71) Applicants: Jack D. Lollis, Tulsa, OK (US); Corey M. Lollis, Tulsa, OK (US)

(72) Inventors: Jack D. Lollis, Tulsa, OK (US); Corey M. Lollis, Tulsa, OK (US)

(21) Appl. No.: 15/094,299

(22) Filed: Apr. 8, 2016

Related U.S. Application Data
(60) Provisional application No. 62/144,660, filed on Apr. 8, 2015.

(51) Int. Cl. F17C 13/06; F16L 55/10

(52) U.S. Cl. CPC F17C 13/06; F16L 55/1018; F17C 2205/0311

(57) ABSTRACT

There is provided herein a pipeline closure which is machined as a single piece. In this embodiment, the pipeline closure comprises a door frame which is integral to a flange containing some number of holes for lug bolts along its periphery, the purpose of the holes being to provide a means of attaching the closure to the end of a pipe as is conventionally done. A door is positionable to be opened to allow access to the interior of the pipe or pressure vessel to which the quick opening closure is attached. Unlike prior art closures, the quick opening closure does not have a weld joint that is a potential weak point in the mechanism. Additionally, this embodiment does not require as much space to mount or attach as prior art closures.

### CROSS REFERENCE TO RELATED APPLICATIONS

This application claims the benefit of U.S. Provisional Patent Application Ser. No. 62/144,660 filed on Apr. 8, 2015, and incorporates said provisional application by reference into this document as if fully set out at this point.

### TECHNICAL FIELD

This disclosure relates generally to equipment for pressure vessels and pipelines and, more specifically, equipment designed to allow quick access to the interior same.

### BACKGROUND

It is well-known in the pressure vessel and pipeline arts that it is occasionally necessary to gain access to the interior of such structures. This might be done for many different reasons, but among them are to provide access for purposes of inspection, cleaning, testing, etc. Such access is needed when, for example, a pipeline pig is inserted into a pipe.

Currently, closure devices that are used to close pressure vessels and the like utilize a number of evenly spaced lug bolts around the perimeter of the closure to provide tight sealing engagement. Unfortunately, these types of closures require considerable time and effort to install and remove and various solutions have been proposed to address this problem.

It is known in the prior art to provide access to the interior of a pipe or pressure vessel by attaching a plain metal disk to its terminus (e.g., a blind flange). Such an arrangement, while effective as a closure, is laborious to remove when access is needed. In such an instance, multiple lug bolts must be removed in order to loosen the closure and remove it. Of course, when the time comes to install the closure again, it will be is necessary to reattach it using the lug nuts previously removed.

In view of the foregoing, it is known to create closures that contain doors in them. The obvious advantage of such an arrangement is that it allows access to the interior of the pipeline without the inconvenience and expense of removing the lug bolts that are situated around the periphery of the closure. However, a closure that incorporates a door is conventionally formed by welding a door mechanism (e.g., one that includes a hub and door) onto a flange that is commensurate in diameter with the pipe. Then, the hub/door combination can be securely attached to the pipeline with lug bolts using the holes provided in the flange. The door provides access to the interior of the pipe or pressure vessel without the necessity of removing the lug bolts. Such arrangements are old and well-known in the art.

However, a disadvantage of this approach is that when the hub is welded onto the flange, the welded seam creates an area of weakness. Because of this, it is necessary and desirable to test the weld (e.g., using X-rays) to ensure that the joint is completely sealed throughout its length. Clearly, this would be critical if the door provides access to pressured contents. Additionally, in instances where the pipeline or pressure vessel terminates next to a structure or proximate to some other object which is not readily movable, creating access by adding a welded hub/flange mechanism increases the length of the pipe or pressure vessel terminus which might make opening the installed door impractical. In such instances, a shorter closure would be beneficial. Of course, one that is built according to the prior art approach would require a welded seam which must similarly be tested to confirm that it can withstand the rigors of pressurized use.

Heretofore, as is well known in the pipeline arts there has been a need for an invention that is designed to overcome the disadvantages of prior art approaches. Accordingly it should now be recognized, as was recognized by the present inventors, that there exists, and has existed for some time, a very real need for a system that would address and solve the above-described and other problems.

Before proceeding to a description of the present invention, however, it should be noted and remembered that the description of the invention which follows, together with the accompanying drawings, should not be construed as limiting the invention to the examples (or embodiments) shown and described. This is so because those skilled in the art to which the invention pertains will be able to devise other forms of this invention within the ambit of the appended claims.

### SUMMARY OF THE INVENTION

According to an embodiment, there is provided a closure for use in pressure vessels, pipelines, and the like which comprises a door element that is attached via a hinge assembly to a flange/hub combination that is forged as a single piece. In this embodiment, the closure comprises a hub that is manufactured to be integral to a flange containing some number of holes for lug nuts along its periphery, with a door mechanism being installed within the hub. Unlike prior art closures, the instant closure does not have a weld joint or seam between the hub and flange, which joint is a potential region of weakness in the closure, especially when the contents behind the door are under a high pressure. In other embodiments the hinge assembly might be replaced by a davit assembly which can be used to open/close the door. Such assemblies might be particularly useful where the closure is to be situated horizontally (e.g., a vertical davit assembly might be used to raise/lower the door) or where the opening is inclined. Such embodiments might be opened and closed manually, or electrically, or hydraulically according to methods well known to those of ordinary skill in the art.

The foregoing has outlined in broad terms some of the more important features of the invention disclosed herein so that the detailed description that follows may be more clearly understood, and so that the contribution of the instant inventors to the art may be better appreciated. The instant invention is not to be limited in its application to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

These and further aspects of the invention are described in detail in the following examples and accompanying drawings.

FIGS. 1A (side view) and 1B (top down view) contain an example of a prior art flanged closure design.

FIG. 2 contains a side view illustration of an embodiment.

FIG. 3 provides a top/plan view of the embodiment of FIG. 2.

### DETAILED DESCRIPTION

While this invention is susceptible of embodiment in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

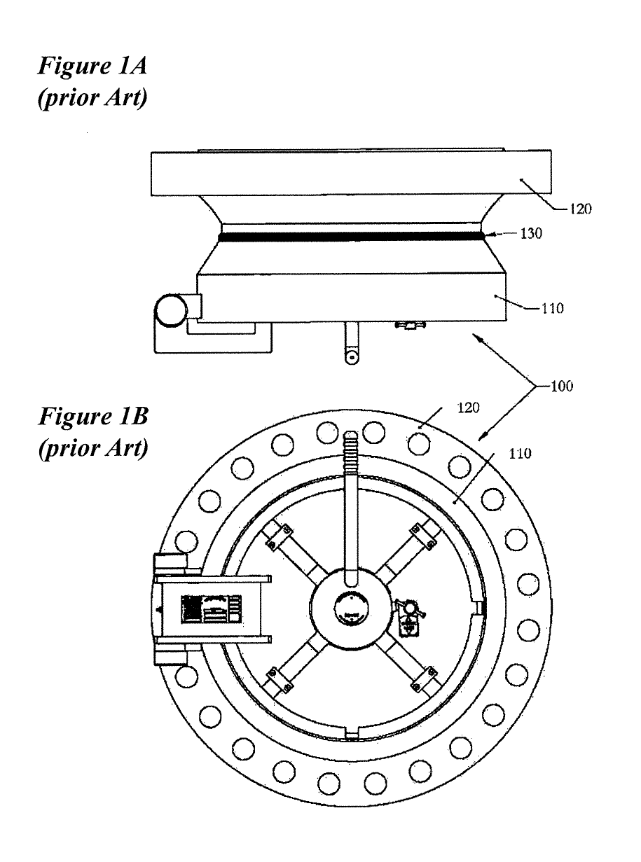

Turning first to FIGS. 1A and 1B, this figure contains an example of a prior art flanged closure for a pressure vessel that includes a door. As indicated, this prior art device 100 is comprised of separately manufactured hub 110 and a flange 120 that are joined together. As is indicated in this figure, this example has a welded seam 130 between the hub 110 and flange 120. As indicated previously, such an arrangement is conventional in the prior art.

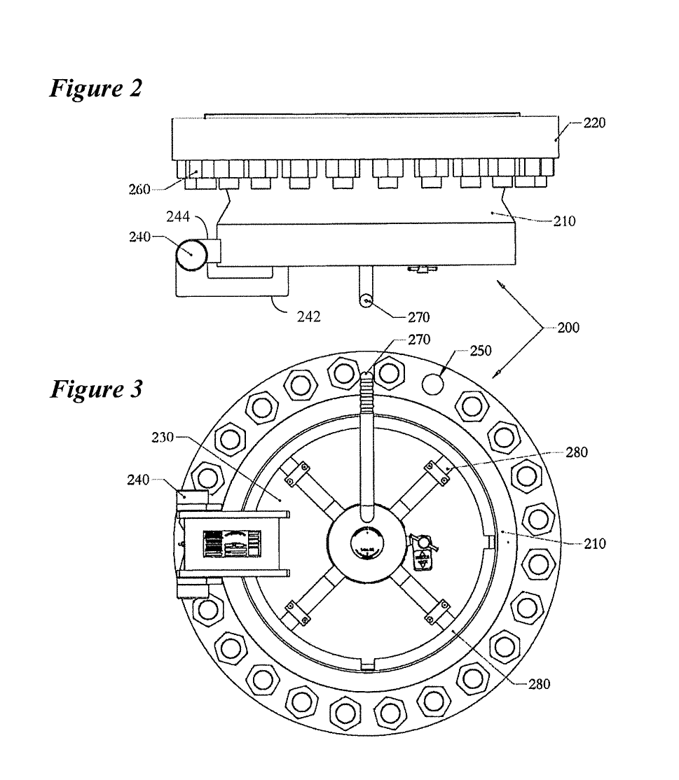

Turning next to FIG. 2, this figure contains an illustration of an embodiment 200, wherein is provided an integrated hub and flange. By “integrated” is meant that the flange and hub of the closure are manufactured to be two parts of a single unit. As such, according to the present disclosure there is no weld that joins the two components together. Thus, for purposes of the instant disclosure the term “unitary closure” will be used to indicate such a weldless arrangement.

In this embodiment, the hub 210 and flange 220 are machined as single piece: there is no welded line of weakness. The door 230 in this embodiment is rotatably mounted on the hub 210 by way of hinge assembly 240, which has, as is conventionally the case, one arm 242 attached to the door 230 and another arm 244 attached to the hub 210. In this embodiment, the door 230 fits within an upper extent of the hub 210 when rotated into a closed position. As is often the case, this particular embodiment the door contains a locking mechanism to secure it in place against the force of pressure from the inside of a pipeline or pressure vessel. Other arrangements are certainly possible and well within those of ordinary skill in the art. Of course, although a hinged attachment is preferred, any sort of attachment that allows the door 230 to be installed and removed in order to provide access to the interior that is protected by the closure 200 would be acceptable.

In some cases, the door 230 might be lowered into place and raised again mechanically or hydraulically. Such an embodiment would not require a hinge assembly. In other instances, a davit assembly or similar crane-type mechanism could be used to close/open a door by moving it into contact with hub. Such assemblies might be particularly useful where the closure was oriented horizontally so that the door would need to be lifted vertically in order to provide access to the pipeline or pressure vessel, or where the opening was inclined from the vertical. Embodiments might be opened and closed manually, or electrically, or hydraulically according to methods well known to those of ordinary skill in the art.

Of particular importance and according to this embodiment, there is no welded seam that joins the hub 210 and flange 220 together. The dashed line in FIG. 2 is there to indicate the thickness of the door 230 when it is placed into a closed position within the hub 210.

With respect to FIG. 3, this figure contains a top/plan view of the embodiment of FIG. 2, again with the door in the closed position. Here is more clearly illustrated an embodiment that includes a handle 270 that is operable to open and close the closure 200. In this embodiment, the handle 270 will operate to radially move locking lug arms 280 away from the periphery of the door 230 (to release the door 230 so it can be opened) and toward the periphery of the door (to lock the door 230 in a closed position). Of course, this is just one of many ways that a door suitable for use with an embodiment might be locked into place to secure it in a closed position so that the contents of a pipeline or pressure vessel can be confined.

Note that, although a hinged door assembly is suitable for use with some embodiments, it is not a requirement. For example, vertically, horizontally, or inclined doors which might be opened via mechanical, hydraulic, or electrical means could also be used with various embodiments, assuming that the closure included an integrated flange and hub. Those of ordinary skill in the art will readily be able to devise other applications in which various embodiments of the invention might be utilized.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

For purposes of the instant disclosure, the term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)−(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

Still further, additional aspects of the instant invention may be found in one or more appendices attached hereto and/or filed herewith, the disclosures of which are incorporated herein by reference as if fully set out at this point.

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An apparatus for securing an opening in a pipe or pressure vessel, comprising:
a. a unitary closure, said unitary closure comprising a flange portion and a hub portion, said flange portion being mateable with the opening in the pipe or pressure vessel; and,
b. a door that is sized to mate with an upper terminus of said hub, thereby closing said closure when so mated and providing access to the opening when placed in an open position.

2. An apparatus for securing an opening in a pipe or pressure vessel according to claim 1, further comprising:
c. a hinge assembly having a first arm mounted on said hub portion of said closure and a second arm affixed to said door, thereby rotatably mounting said door on said unitary closure.

3. An apparatus according to claim 1, wherein said flange portion has a plurality of holes situated around a periphery of said flange portion, said holes being mateable with a corresponding number of holes on the pipe or pressure vessel to allow said flange portion to be bolted thereto.

4. An apparatus for securing an opening in a pipe or pressure vessel according to claim 1, further comprising:
c. a davit assembly in mechanical communication with said door, said davit assembly at least for opening and closing said door.

5. An apparatus for securing an opening in a pipe or pressure vessel, comprising:
a. a unitary closure machined as a single piece having an upper portion and a lower portion, wherein said upper portion comprises a hub and said lower portion comprises a flange, wherein said flange is sized to mate with the opening in the pipe or pressure vessel and wherein there is no welded seam between said hub and said flange;
b. a hinge assembly mounted on said hub; said hinge assembly having a first arm and a second arm, said first arm being affixed to said hub, and,
c. a door rotatably mounted on said hub by said hinge assembly, said hinge assembly second arm being affixed to said door, said door at least for providing access to the opening when placed in an open position.

6. An apparatus according to claim 5, wherein said flange portion has a plurality of holes around a periphery of said flange portion, said holes being mateable with corresponding holes on the pipe or pressure vessel to allow said flange portion to be bolted thereto.
